(19) United States
(12) Patent Application Publication
(10) Pub. No.: US 2024/0402337 A1
(43) Pub. Date: Dec. 5, 2024

(54) REMOTE PRESENCE DETECTION SYSTEM

(71) Applicant: Elliptic Laboratories ASA, Olso (NO)

(72) Inventor: Espen KLOVNING, Strommen (NO)

(73) Assignee: Elliptic Laboratories ASA, Olso (NO)

(21) Appl. No.: 18/702,137

(22) PCT Filed: Nov. 3, 2022
(86) PCT No.: PCT/EP2022/080707

§ 371 Date: Apr. 17, 2024

(30) Foreign Application Priority Data
Nov. 5, 2021 (NO) 20211334

(51) Int. Cl. G01S 17/04

(52) U.S. Cl. CPC G01S 17/04

(57) ABSTRACT

The present invention relates to a system and electronic device for detecting and monitoring user presence in the vicinity of the devices in the system. The device including a processor configured to, based on received sensor inputs, to detect a user presence, providing an indication signal to a processing and communication unit indicating whether or not the user is present. The processing and communication unit being configured to communicate the indication signal to at least one other device in a communication network.

The present invention relates to a presence detection system, especially for detecting potential users of an electronic device or system

Modern group applications use available information to indicate whether a user is active, present, away, blocked, busy, etc to give other information about their current status and willingness to communicate directly using audio/video conferencing etc. These indicators are usually linked to actions taken by the user that the user allow friends and family to see. Even other people may access the presence information if the user so desires.

With the advent of presence detection sensors (e.g. ToF, UWB, radar, ultrasound, etc) the presence state does not rely solely on specific user actions (e.g. touching screen, typing, recording, using input devices, logged in, etc) anymore. The presence detection sensors may indicate that there is someone in front or close by the remote device even without being logged in. The field-of-view of presence detection sensors will vary and make the detection zone different from device to device. If available, the information can be extracted from the presence detection sensor and made available to other parties. WO2021/0219039 describes a system where a user accessing a device in a system may share customizable features in the system.

Sensors and methods for detecting targets close to a system, e.g. for sensing the activity is known, e.g. from US2017/0139031 and US2014/0092710, where passive sensors are used for localizing acoustic sources. Active presence detection is also discussed in WO2021/045628 as well as in simultaneously filed patent applications NO20211332 and NO20211333 which are incorporated here by way of reference.

The present invention is aimed at a system providing presence detection and utilizing it in a communication system. The presence of a user may be based on acoustic measurements as well as other measurements related to the user activity. This is achieved as specified in the accompanying claims.

Based on the present invention, it is possible to use presence detection sensors for more than presence detection on the local device for security reasons (e.g. Human Presence Detection in laptops). It can be used as presence indicators for group applications such as Microsoft Teams, Cisco WebEx, Messenger, etc where users can, if allowed to, access the presence indicators of a remote user. Access to these presence indicators should be controlled by the remote user to make sure that the information is not misused.

The presence detection information will be communicated to either a distributed or centralized entity that keeps track of user status of all the users controlled or known in the group in question. All the users can subscribe to user status updates from either all subscribing users or a preferred set of users (e.g. members of the same organization, contacts, friends, etc). Although direct communication of user status between specific users may be done, the most common setup is that the centralized user-status controller will keep track of the user status of all users according to the permissions they have granted individually or the permissions their organization has accepted.

The present invention will be discussed below with reference to the accompanying drawings, illustrating the invention by way of examples.

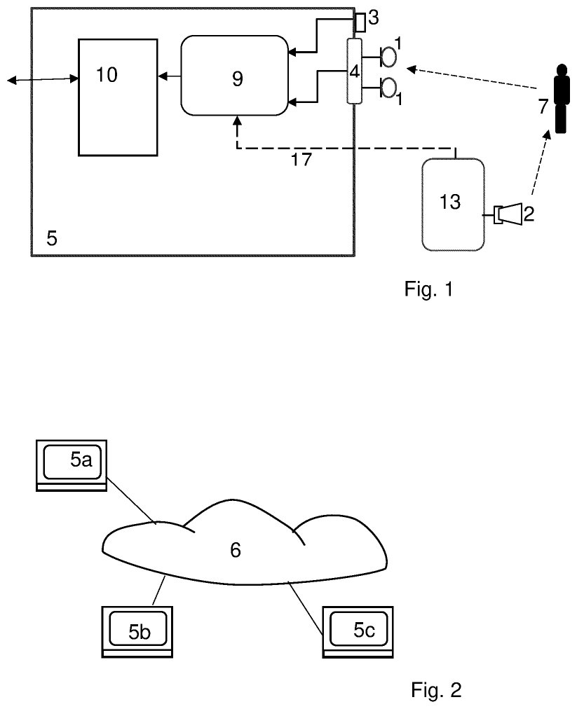

FIG. 1 illustrates a device including present detection and monitoring according to the invention.

FIG. 2 illustrates a number of devices in a computer network wherein at least one includes presence detection.

As illustrated in FIG. 1 the present invention relates to a device 5 configured to detect and monitor the presence of a possible user 7. The device 5 may for example be a computer, phone, gaming console or tablet. The device will typically include at least one microphone 1 connected through an interface to a processor 9 for detecting sounds and activity in the vicinity of the device. The processor may be configured to recognize specific sounds, for example based on frequency range and time or the voice of a known user. Using two or more microphones 1 it may also be configured to recognize the position of the acoustic source and distance from the device. The signal recognition may also be recognized using a machine learning algorithm based on previous user activities in the area in relation to the device. Other types of sensors 3 may also be used such as radar, keyboard activity, camera, etc, and the combination of them may also be used to increase the certainty of the presence detections.

The invention may also include an active acoustic source 13 independently of or incorporated into the device connected to a speaker or other transducer 2 for transmitting an acoustic signal. The source may be configured to communicate a reference signal 17 to the processor 9 so as measure the time or phase difference between the transmitted signal and the received signal. The transmitted signal may be in the ultrasound range and/or in the audible range.

As an alternative, the acoustic source is independent of the device, where the device is configured to detect, through at least two microphones 1, the reflections of a transmitted signal, for based on amplitude and phase as well as other processing detecting the presence of a user.

The device also includes a processor and communication unit 10 with user interface, storage means for data and user input and per se known communication means for communication with a computer network.

According to the present invention the device is part of a remotely controlled system or a network with several devices 5a,5b,5c connected together in a common network 6, as is illustrated in FIG. 2. The network 6 may to be a distributed or centralized entity capable of keeping track of user status of all the users controlled or known in the group in question. The network may include a user database maintaining information about the user privacy settings and administration levels or rights in the system.

The presence detection mechanism at a first remote device 5a can keep track of presence activity over a configurable time (e.g. presence history windows) and if configured to do so, allow a user on another device 5b to get access to that information. The presence history can be used by the remote user too. It will provide information about any user coming in close contact with the remote device 5a. This information can be made available to the remote user on other device 5b,5c in his/her possession and could be used to secure the remote device better.

The remote presence detection can also be used to control how the device 5a is handling the calling process at the remote end. If there is no remote user there but the user still wants to go ahead with the call hoping the remote user is still close by the remote device, the ring tone can be played, if configured by the user or according to some organization policy, the ring tone can be played normally. If the remote user is in front of the device according to the presence detection scheme, the ring tone could be optional or at least subdued to avoid disturbing other people close by. Visual indicators may be used in these cases as a less noisy alternative.

Access to remote presence detection allows a user to subscribe to changes to the presence detection state of at least one remote user. Once at least one or a selected few of the remote devices will indicate presence, the first user can be notified and contact all the remote users at the same time to start communicating using the preferred communication channel.

If the communication channel should not be started until at least one of the required remote users are present but based on other information is not available for any communication, the user may select to wait until all the users are both present and available.

The user may choose to instruct the system to overlook available user according to their presence detection state if the desired communication is of importance. It is also possible to set up an automatic redial once all the required remote users enter their presence detection zones respectively based on indications from their remote presence detection sensors. Alternatively, the remote device may display a message that displays the intent of the user to get in touch. The message could include elements that allows the remote user to answer the communication request immediately (e.g. callback button, etc) that is to accept or deny the request. The configuration of the group application or potentially the request from the initiating user may delay setting up the communication channel until all the required participants are present. Optionally, remote users may be overlooked in this scenario.

To summarize the present invention is related to an electronic device and a system including the device. The device is suitable for detecting and monitoring user presence in the vicinity of the device and includes a processor configured to, based on received sensor inputs, to detect a user presence. At request from an external device or automatically activated by the device provides an indication signal to a processing and communication unit indicating whether or not the user is present, The processing and communication unit is configured to communicate the indication signal to at least one other device in a communication network.

The processing and communication unit may include a user interface such as screen, keyboard, voice recognition or touchpad, for requesting permission from the user to allow the presence indication to be communicated to a remote unit in said network, and for storing said permission in a data storage.

The processing and communication unit may be configured to communicate with other devices in the network for requesting or allowing communication of said presence indications in the network. The other device in the network may be a centralized server or server network including a computer storage for controlling the access and information related to the users and devices.

The processing and communication unit may be configured to allowing remote control of the device through communication from said network.

The system according to the present invention includes a number of devices as described above and allows communication between at least two of the processing and communication units of the devices, where the communication includes the user presence indication allowing at least one other computer in the network to receive the information. The other computer may preferably be a distributed or centralized computer entity configured to maintain and control the status all the users controlled or known in a selected group, the entity preferably including a user database maintaining information about the user privacy settings and administration levels or rights in the system.

1. An electronic device for detecting and monitoring user presence in the vicinity of the device, the electronic device comprising a processor configured to, based on received sensor inputs, to monitor the device vicinity in order to detect a user presence, providing an indication signal to a processing and communication unit indicating whether or not the user is present, the processing and communication unit being configured to communicate the indication signal to at least one other device in a communication network.

2. The electronic device according to claim 1, wherein the processing and communication unit comprises a user interface such as screen, keyboard, voice recognition or touchpad, for requesting permission from the user to allow the presence indication to be communicated to a remote unit in the network, and for storing the permission in a data storage.

3. The electronic device according to claim 1, wherein the processing and communication unit is configured to communicate with other devices in the network for requesting or allowing communication of the presence indications in the network.

4. The electronic device according to claim 1, wherein the processing and communication unit comprises means for allowing remote control of the device through communication from the network.

5. The electronic device according to claim 1, wherein the other device in the network is a centralized server or server network comprising a computer storage for controlling the access and information related to the users and devices.

6. A system comprising at least two devices according to claim 1 and allowing communication between the devices processing and communication units, comprising the user presence indication, allowing at least one other computer in the network to receive the information.

7. The system according to claim 6, wherein the system comprises a distributed or centralized computer entity configured to maintain and control the status all the users controlled or known in a selected group.

8. The system according to claim 7, wherein the entity comprises a user database maintaining information about the user privacy settings and administration levels or rights in the system.
